(19) United States
(12) Patent Application Publication
(10) Pub. No.: US 2026/0273481 A1
(43) Pub. Date: Sep. 17, 2026

(54) METHOD OF MANUFACTURING ULTRAFINE BUBBLE-CONTAINING LIQUID

(71) Applicants: Yuki TSUCHIYA, Kanagawa (JP); Yasunori TAKAHASHI, Kanagawa (JP); Tsuneaki KONDOH, Kanagawa (JP); Shunsuke KOBAYASHI, Kanagawa (JP); Huizee THEN, Kanagawa (JP)

(72) Inventors: Yuki TSUCHIYA, Kanagawa (JP); Yasunori TAKAHASHI, Kanagawa (JP); Tsuneaki KONDOH, Kanagawa (JP); Shunsuke KOBAYASHI, Kanagawa (JP); Huizee THEN, Kanagawa (JP)

(21) Appl. No.: 19/554,695

(22) Filed: Mar. 3, 2026

(30) Foreign Application Priority Data
Mar. 12, 2025 (JP) 2025-039624

(51) Int. Cl. B01F 23/40; B01F 33/302

(52) U.S. Cl. CPC B01F 23/405; B01F 23/48; B01F 33/3022

(57) ABSTRACT

A method of manufacturing an ultrafine bubble-containing liquid having a high concentration is provided. The method of manufacturing an ultrafine bubble-containing liquid comprises: a supply step of supplying a liquid to a liquid supply region provided in which a discharge port forming member having a discharge port with a minute diameter is arranged; and a discharge step of pressurizing the liquid supplied to the liquid supply region and discharging the liquid as a liquid droplet from the discharge port. The liquid contains one or more nuclei, the nuclei are substances containing carbon atoms and have a diameter less than or equal to 100 nm, and the discharge step is a step of discharging the liquid droplet so as to collide with a collision member, wherein a flight velocity of the liquid droplet upon colliding with the collision member is greater than or equal to 1 m/s.

### CROSS-REFERENCE TO RELATED APPLICATION

The present application claims priority under 35 U.S.C. § 119 to Japanese Patent Application No. 2025-039624, filed on Mar. 12, 2025, the content of which is incorporated herein by reference in its entirety.

### BACKGROUND OF THE INVENTION

### Field of the Invention

The present invention relates to a method of manufacturing an ultrafine bubble-containing liquid.

### Description of the Related Art

It is known that a liquid containing ultrafine bubbles (UFBs) having a diameter of less than 1.0 μm has good cleaning power and sterilizing power. From the viewpoint of maintaining the effectiveness of the UFB-containing liquid such as cleaning power and sterilizing power, it is desirable that the UFBs remain in the liquid without rising to the liquid surface.

In order to manufacture a highly concentrated UFB-containing liquid, it is preferable not to generate bubbles having a diameter greater than or equal to 1.0 μm, and in recent years, an inkjet discharge method has been adopted as a method of manufacturing a UFB-containing liquid.

For example, Japanese Patent Application Laid-Open Publication No. 2023-068937 discloses a method of manufacturing an ultrafine bubble-containing liquid including a supply step of supplying a liquid containing at least one substance such as an organic liquid to a liquid supply region in which a discharge port forming member having a discharge port with a minute diameter is arranged, and a discharge step of pressurizing the liquid supplied to the liquid supply region by a pressurizing means in contact with the liquid and discharging the liquid from the discharge port as liquid droplets to a collection unit.

### SUMMARY OF THE INVENTION

However, in the conventional method of manufacturing an ultrafine bubble-containing liquid as described in Japanese Patent Application Laid-Open Publication No. 2023-068937, when the manufactured ultrafine bubble-containing liquid is used for cleaning, for example, the concentration of the ultrafine bubbles might not be sufficient.

It is an object of the present invention to provide a method of manufacturing an ultrafine bubble-containing liquid capable of manufacturing an ultrafine bubble-containing liquid of high concentration.

A method of manufacturing an ultrafine bubble-containing liquid according to an embodiment comprises: a supply step of supplying a liquid to a liquid supply region provided in which a discharge port forming member having a discharge port with a minute diameter is arranged; and a discharge step of pressurizing the liquid supplied to the liquid supply region and discharging the liquid as a liquid droplet from the discharge port. The liquid contains one or more nuclei, the nuclei are substances containing carbon atoms and have a diameter less than or equal to 100 nm, and the discharge step is a step of discharging the liquid droplet so as to collide with a collision member, wherein a flight velocity of the liquid droplet upon colliding with the collision member is greater than or equal to 1 m/s.

According to an embodiment of the present invention, it is possible to provide a method of manufacturing an ultrafine bubble-containing liquid which can manufacture an ultrafine bubble-containing liquid having high concentration.

### BRIEF DESCRIPTION OF THE DRAWINGS

FIG. 1 is a schematic cross-sectional view showing an apparatus for manufacturing a UFB-containing liquid used in a method of manufacturing a UFB-containing liquid according to a first embodiment;

FIG. 2 is a schematic cross-sectional view showing a liquid discharge head of the apparatus for manufacturing a UFB-containing liquid shown in FIG. 1;

FIG. 3 is a block diagram for describing a control unit of the apparatus for manufacturing a UFB-containing liquid according to the first embodiment;

FIG. 4 is a schematic diagram for describing a method of manufacturing a UFB-containing liquid according to the first embodiment;

FIG. 5 is a schematic cross-sectional view showing an apparatus for manufacturing a UFB-containing liquid used in a method of manufacturing a UFB-containing liquid according to a second embodiment;

FIG. 6 is a schematic cross-sectional view showing a liquid discharge head of the apparatus for manufacturing a UFB-containing liquid shown in FIG. 5;

FIG. 7 is a block diagram for describing a control unit of an apparatus for manufacturing a UFB-containing liquid according to the second embodiment;

FIG. 8A is a schematic diagram for describing a method of manufacturing a UFB-containing liquid according to the second embodiment;

FIG. 8B is a schematic diagram for describing the method of manufacturing a UFB-containing liquid according to the second embodiment;

FIG. 9 is a schematic diagram for describing another example of the method of manufacturing a UFB-containing liquid according to the second embodiment;

FIG. 10 is a schematic cross-sectional view for describing another example of a liquid discharge head of an apparatus for manufacturing a UFB-containing liquid used in a method of manufacturing a UFB-containing liquid according to a third embodiment; and

FIG. 11 is a schematic diagram for describing a method of manufacturing a UFB-containing liquid according to the third embodiment.

### DETAILED DESCRIPTION OF THE DISCLOSURE

Embodiments of the present invention will now be described with reference to the accompanying drawings. In each of the drawings, identical components are denoted by the same reference numerals, and redundant descriptions will be appropriately omitted.

The following embodiments do not limit the present invention to the following embodiments. The dimensions, materials, shapes, relative arrangements, and the like of the components described below are not intended to limit the scope of the present invention, but are intended to be illustrative, unless otherwise specified. In addition, the sizes and positional relationships of the members shown in the drawings may be exaggerated in order to clarify the description. In this specification, the term “ultrafine bubble” indicates a bubble having a diameter of less than 1.0 μm, and may be referred to as a “UFB”.

### First Embodiment

### <Apparatus for Manufacturing UFB-Containing Liquid>

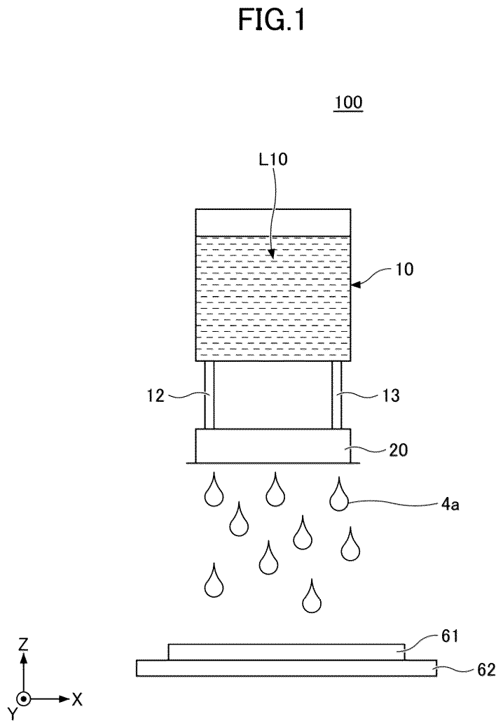

FIG. 1 is a schematic cross-sectional view showing an apparatus for manufacturing a UFB-containing liquid used in a method of manufacturing a UFB-containing liquid according to a first embodiment. As shown in FIG. 1, an apparatus 100 for manufacturing a UFB-containing liquid (which hereinafter may be referred to as a “manufacturing apparatus 100”) has a supply unit 10 serving as a liquid supply means for supplying liquid L10 and a liquid discharge head 20 serving as a discharge means.

The supply unit 10 supplies the liquid L10, which is supplied into the supply unit 10 by a pump or the like, to the liquid discharge head 20 via the supply channel 12. The liquid discharge head 20 pressurizes the liquid L10 supplied from the supply unit 10 and discharges it as liquid droplets 4a. At this time, the liquid droplets 4a are discharged so as to collide with a collision member 61. The UFB-containing liquid is obtained by causing the liquid droplets 4a to collide with the collision member 61.

Within the liquid L10 supplied to the liquid discharge head 20, the liquid L10 not used for discharging the liquid droplets may be returned to the supply unit 10 via a recovery channel 13 by a pump or the like (not shown) and circulated. The liquid discharge head 20 need not be provided with the above-described circulation mechanism.

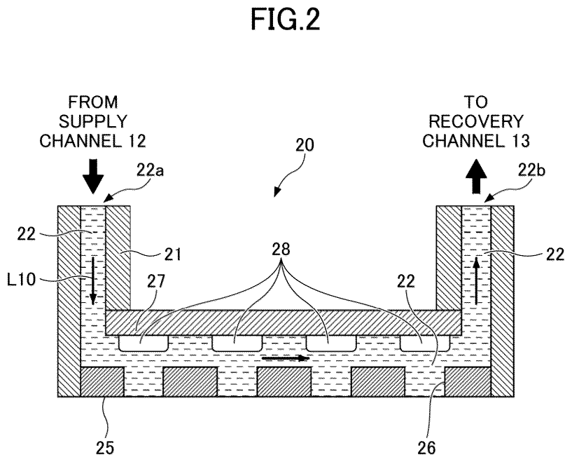

The liquid discharge head will be described in detail with reference to FIG. 2. FIG. 2 is a schematic cross-sectional view showing a liquid discharge head of the apparatus for manufacturing a UFB-containing liquid shown in FIG. 1. The liquid discharge head 20 is a functional component for discharging liquid from a nozzle.

Energy sources for discharging liquid include, for example, a piezoelectric actuator (a laminated piezoelectric element and a thin-film piezoelectric element), a thermal actuator using an electrothermal conversion element such as a heating resistor, and an electrostatic actuator composed of a diaphragm and a counter electrode.

As shown in FIG. 2, the liquid discharge head 20 has a channel forming member 21 for forming a channel 22 from a liquid inflow port 22a to a liquid outflow port 22b. The liquid inflow port 22a is connected to a supply channel 12 shown in FIG. 1, and the liquid outflow port 22b is connected to the recovery channel 13 shown in FIG. 1.

Part of the channel forming member 21 is provided with a plate-shaped discharge port forming member 25 in which a plurality of minute discharge ports 26 are formed, and an element holding member 27 at a position opposed to the discharge port forming member 25. The element holding member 27 is provided with a plurality of piezoelectric elements (pressurizing means) 28 opposed to the discharge ports 26.

The diameter of each discharge port 26 is not particularly limited as long as the UFBs can be manufactured in the method of manufacturing a UFB-containing liquid of the present invention, and can be appropriately selected according to the purpose, but it is preferable to have a minute diameter, that is, from 0.1 μm to 100 μm.

The number of discharge ports 26 formed in the discharge port forming member 25 is not particularly limited, can be appropriately selected according to the purpose, and may be one or more, but it is preferable to provide one piezoelectric element for each discharge port.

The piezoelectric element 28 is in contact with the liquid L10 filled in the flow path 22, which is the liquid supply region, and is displaced toward the discharge port 26 by a drive voltage (drive pulse) applied from a drive means (not shown), thereby directly pressurizing the liquid L10. Due to this pressurizing, the liquid L10 filled in the flow path 22 and the discharge port 26 is discharged from the discharge port 26 as the liquid droplets 4a.

Examples of the collision member 61 include a silicon wafer, a glass substrate, a metal substrate, or the like. The shape of the collision member 61 is not particularly limited and can be appropriately selected according to the purpose, but it is preferable that the liquid droplet collision surface of the collision member 61 is smooth.

Specifically, the surface roughness Ra of the liquid droplet impact surface of the collision member 61 is preferably about 0.2 μm. The surface roughness Ra can be measured by, for example, image analysis using a laser microscope or the like.

The Young's modulus of the collision member 61 is preferably greater than or equal to 68.6 Gpa (kN/mm²), and more preferably greater than or equal to 70 Gpa (kN/mm²).

The Young's modulus of the collision member 61 can be measured by, for example, detecting the deflection (hmm) when a load (PN) is applied to a central portion of a plate sample (dmm×bmm×Lmm) supported at both ends by a differential transformer, and calculating the Young's modulus E (N/m²) based on Equation (1).

$$\begin{matrix}( Math . 1 ) & \\ E = \frac{1}{4} ( \frac{{L}^{3}}{{d}^{3} \cdot b} ) ( \frac{P}{h} ) \times 1 {0}^{6} & ( 1 )\end{matrix}$$

The collision member 61 may be supported by a collision member support section 62. The material, shape, size, and structure of the collision member support section 62 are not particularly limited as long as the collision member 61 can be supported, and may be appropriately selected according to the purpose.

The manufacturing apparatus 100 may include a collision member rotating unit (not shown) for rotating the collision member 61, with an axis along a vertical direction (Z-axis direction) as the rotation center axis. In this case, the collision member rotating unit may include the collision member support section 62. The collision member rotating unit may include, for example, a spin coater.

The manufacturing apparatus 100 may include a moving means for moving the liquid discharge head 20 and the collision member 61 (or the collision member support section 62 supporting the liquid discharge head) so that a flight velocity of the liquid droplets 4a at the time of collision with the collision member 61 is greater than or equal to 1 m/s.

The manufacturing apparatus 100 may include a collecting means for collecting the ultrafine bubble-containing liquid. The recovery means includes, for example, a spin coater with a waste liquid recovery mechanism.

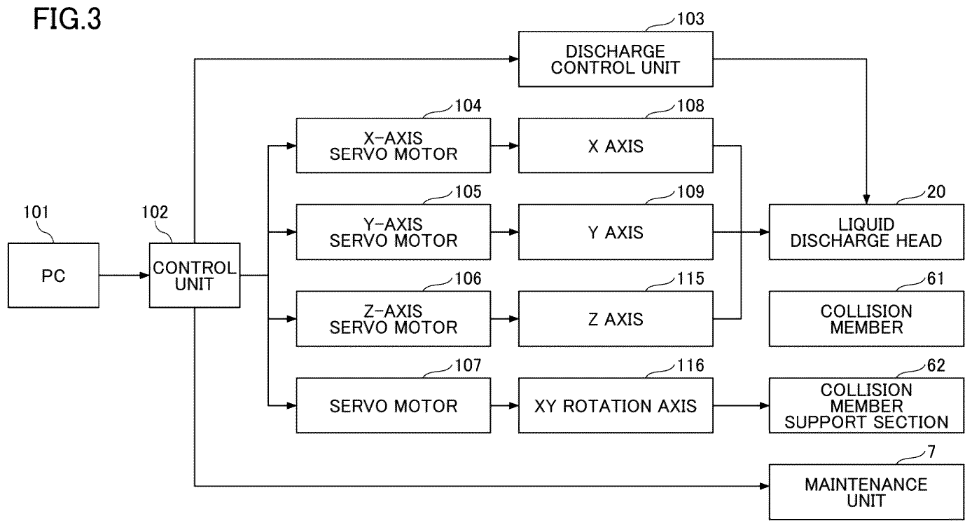

The manufacturing apparatus 100 includes a PC 101. FIG. 3 is a block diagram for describing a control unit of the manufacturing apparatus for a UFB-containing liquid according to the first embodiment. As shown in FIG. 3, the PC 101 includes a control unit 102.

The control unit 102 may appropriately include a CPU for controlling the entire manufacturing apparatus 100, programs including a program for causing the CPU to control the operation of the apparatus, a ROM for storing other fixed data, a RAM for temporarily storing data, and the like.

The control unit 102 controls a discharge control unit 103 for controlling the discharge of the liquid discharge head 20. The control unit 102 also controls an X-axis servo motor 104 for controlling scanning of an X axis 108 of the liquid discharge head 20, a Y-axis servo motor 105 for controlling scanning of a Y axis 109 of the liquid discharge head 20, and a Z-axis servo motor 106 for controlling scanning of a Z axis 115 of the liquid discharge head 20. Further, the control unit 102 controls a servo motor 107 for controlling an XY rotation axis 116 of the collision member support section 62 for rotating the collision member 61 on the XY plane (horizontal plane).

Although the present embodiment is a mode in which the collision member 61 is used in a spin coater serving as a collision member rotating unit, the present invention is not limited to this mode.

A maintenance unit 7 is a mechanism for discharging the liquid on the nozzle surface of the liquid discharge head 20, and includes, for example, a mechanism including a cap for capping the nozzle surface of the liquid discharge head 20, a suction pump connected to the cap, a wiper member, and the like. The maintenance unit 7 having such a mechanism, when performing a maintenance operation, sucks out and discharges the liquid from the nozzle by capping the nozzle surface with the cap and performing suction with the suction pump.

### <Method of Manufacturing UFB-Containing Liquid>

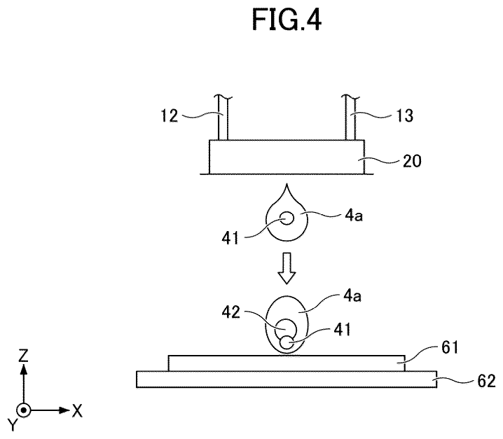

FIG. 4 is a schematic diagram for describing a method of manufacturing a UFB-containing liquid according to the first embodiment. The method of manufacturing a UFB-containing liquid according to the first embodiment includes a supply step of supplying the liquid L10 to a liquid supply region provided with a discharge port forming member 25 having a discharge port 26 with a minute diameter, and a discharge step of pressurizing the liquid L10 supplied to the liquid supply region and discharging the liquid L10 from the discharge port 26 as liquid droplets 4a, as shown in FIG. 4. The supply step and the discharge step may be performed using the manufacturing apparatus 100. The supply step and the discharge step may be inkjet processes.

### (Supply Step)

The liquid L10 contains one or more nuclei 41. The nuclei 41 are substances containing carbon atoms and have a diameter less than or equal to 100 nm. Here, the diameter means a maximum value of the diameter. The substances containing carbon atoms are substances containing one or more carbon atoms and may be, for example, an organic compound. The diameter of the nuclei 41 can be confirmed by observation using an SEM (Scanning Electron Microscope) or TEM (Transmission Electron Microscopy).

The liquid L10 may be a liquid containing an organic substance. Specifically, the liquid L10 may contain an organic solvent. Examples of the organic solvent include alcohols such as methanol, ethanol, and isopropyl alcohol, and unsaturated fatty acids such as oleic acid. The liquid L10 may contain one type or two or more types of these.

The liquid L10 may contain a carbon-containing liquid having a dissolved gas amount larger than that of ultrapure water, and ultrapure water. The dissolved gas amount is, for example, a dissolved oxygen amount. The dissolved oxygen amount can be measured by a liquid determination method, a diaphragm electrode method, or a fluorescence method.

When the liquid L10 contains a carbon-containing liquid having a dissolved gas amount larger than that of ultrapure water, and ultrapure water, the content of the liquid having a dissolved gas amount larger than that of the ultrapure water may be, for example, greater than 0 mass % and less than 100 mass % with respect to the liquid L10.

The liquid L10 may include a carbon-containing liquid having a dissolved gas amount smaller than that of ultrapure water, and ultrapure water. The liquid L10 may include a carbon-containing liquid having a dissolved gas amount larger or smaller than that of ultrapure water, and a liquid other than ultrapure water. Examples of the liquid other than ultrapure water include ozone water and hydrogen peroxide water.

The viscosity of the liquid L10 is not particularly limited as long as it can be discharged from the liquid discharge head 20, and can be appropriately selected according to the purpose, but is preferably less than or equal to 30 mPa·s under normal temperature and pressure. A liquid having a viscosity less than or equal to 30 mPa·s due to heating or cooling may be used. The viscosity of the liquid can be measured by, for example, DV2T (manufactured by Brookfield Corporation).

The surface tension of the liquid is preferably less than or equal to 80 mN/m. The surface tension of the liquid can be measured by, for example, a DY-700 (manufactured by Kyowa Interface Science Co., Ltd.).

### (Discharge Step)

As shown in FIG. 4, the discharge step is a step of discharging the liquid droplets 4a so as to collide with the collision member 61. The flight velocity of the liquid droplets 4a at the time of colliding with the collision member 61 is greater than or equal to 1 m/s. With this configuration, according to the method of manufacturing a UFB-containing liquid of this embodiment, it is possible to manufacture a liquid containing a high concentration of UFBs.

Specifically, when the liquid droplets 4a containing the nuclei 41 collide with the collision member 61 at a flight velocity greater than or equal to 1 m/s, the following three phenomena are considered. (1) Liquid in the liquid droplets 4a is vaporized by the pressure fluctuation at the time of collision, thereby generating the UFBs 42. (2) The liquid droplets 4a entrain the surrounding outside air at the time of collision, thereby generating the UFBs 42. (3) In the discharge step, the liquid droplets 4a entrain the outside air, microbubbles (bubbles having a diameter greater than or equal to 1 μm and less than 100 μm) are generated in the liquid droplets 4a, and the microbubbles are crushed and divided upon collision, thereby generating the UFBs 42.

As a result of the above, it is possible to improve the concentration of the UFBs 42 in the liquid droplets 4a. Since the UFB-containing liquid obtained by the method of manufacturing a UFB-containing liquid of the present embodiment has a higher concentration of UFBs than the conventional liquid, the effects obtained by the UFBs, that is, the effects such as bactericidal power and cleaning power, are superior. In this specification, the term “high concentration” can mean, for example, greater than or equal to 300 million cells/mL.

The volume of the liquid L10 discharged from the discharge port 26 is preferably greater than or equal to 1 pL and less than or equal to 10 pL.

The flight velocity of the liquid droplets 4a upon colliding with the collision member 61 is preferably greater than or equal to 1 m/s and less than or equal to 20 m/s, from the viewpoint of efficiently generating the UFBs 42.

The discharge direction of the liquid droplets 4a in the discharge step is preferably perpendicular to the collision surface of the liquid droplets 4a on the collision member 61, from the viewpoint of efficiently generating the UFBs 42.

In the discharge step, the distance between the discharge port 26 and the collision member 61 is preferably greater than or equal to 0.1 mm and less than or equal to 30 mm, and more preferably greater than or equal to 0.5 mm and less than or equal to 10 mm, from the viewpoint of increasing the UFB concentration.

In the discharge step, the collision member 61 may be cooled by a collision member cooling unit (not shown), from the viewpoint of efficiently generating the UFBs. The cooling temperature is preferably greater than or equal to the freezing point of the liquid L10 and less than or equal to room temperature (25° C.). As another option, the collision member cooling unit may be provided in the apparatus 100 for manufacturing a UFB-containing liquid, or a collision member cooling unit may be separately provided when manufacturing the UFB-containing liquid.

In the discharge step, the liquid droplets 4a may be discharged while the collision member 61 is rotating. In this case, the collision member 61 is rotated by the collision member rotating unit. Thus, according to the method of manufacturing the UFB-containing liquid of the present embodiment, when the collision member 61 is an object to be cleaned, the UFB-containing liquid with a high concentration is manufactured on the collision member 61, and the UFB-containing liquid is diffused to the surface of the collision member 61 by the rotational centrifugal force, so that the entire surface of the collision member 61 can be cleaned. The collision member rotating unit includes, for example, a spin coater used in a spin coating method or the like.

The contact angle between the collision member 61 and the liquid droplets 4a is preferably greater than or equal to 90°, from the viewpoints of easy entrainment of outside air and easy breaking of entrained bubbles.

The method of manufacturing a UFB-containing liquid of the present embodiment may include, as another step, a recovery step for recovering the ultrafine bubble-containing liquid after the discharge step. The recovery step is suitably performed by a recovery means such as a spin coater equipped with a waste liquid recovery mechanism.

### Second Embodiment

### (Apparatus for Manufacturing the UFB-Containing Liquid)

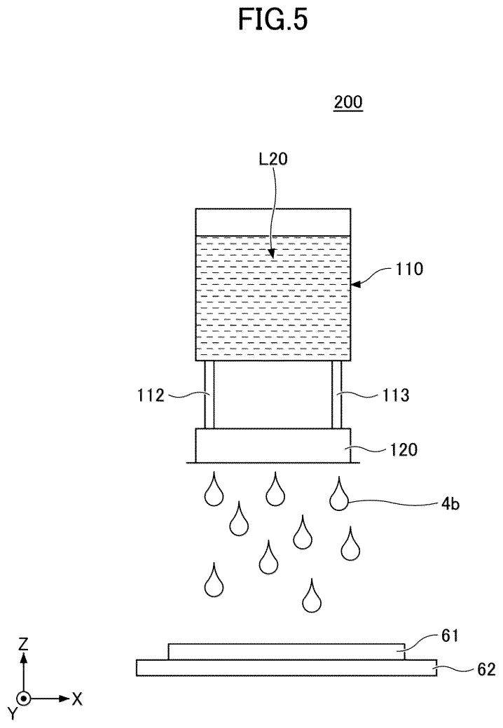

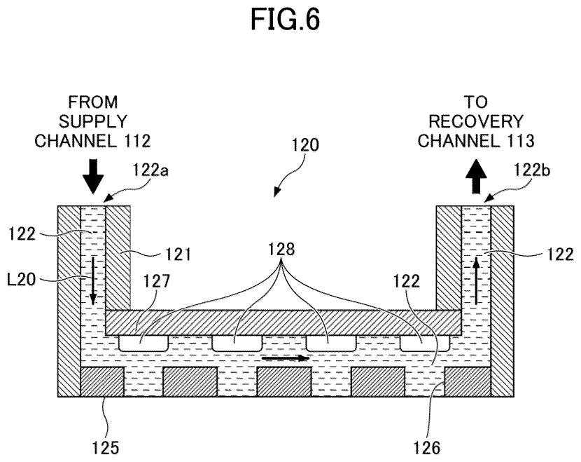

FIG. 5 is a schematic cross-sectional view showing an apparatus for manufacturing a UFB-containing liquid used in the method of manufacturing a UFB-containing liquid according to the second embodiment. FIG. 6 is a schematic cross-sectional view showing the liquid discharge head of the apparatus for manufacturing a UFB-containing liquid shown in FIG. 5.

The apparatus for manufacturing a UFB-containing liquid 200 (which hereinafter may be referred to as a “manufacturing apparatus 200”) used in the method of manufacturing a UFB-containing liquid according to the second embodiment is different from the manufacturing apparatus 100 in that the liquid L10 in the manufacturing apparatus 100 is changed to a second liquid L20, and in that the apparatus includes a pump 8 and a nozzle 9 for the first liquid L10. Since the apparatus 200 for manufacturing a UFB-containing liquid can have the same configuration as that of the apparatus 100 for manufacturing a UFB-containing liquid except for the above points, descriptions of identical configurations may be omitted.

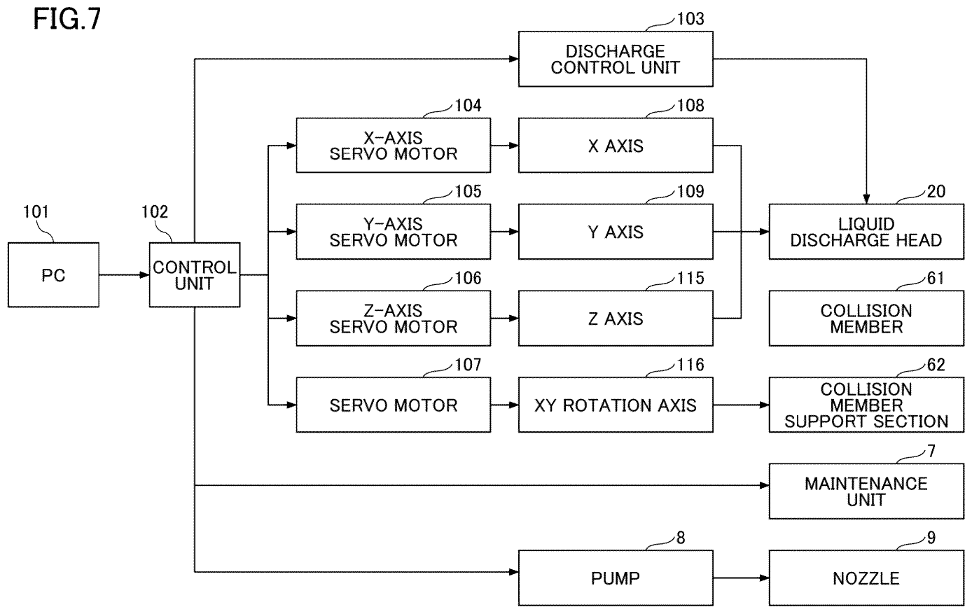

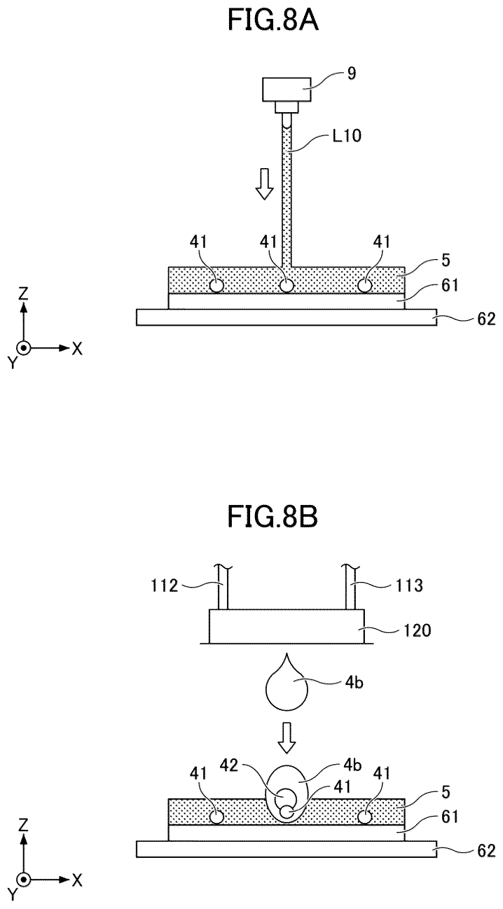

The apparatus 200 for manufacturing a UFB-containing liquid includes a supply unit (not shown) as a liquid supply means for supplying the first liquid L10, the nozzle 9 (FIG. 8A) as a discharge means, and the pump 8 (FIG. 7) for sending the liquid to the nozzle 9. Here, since the first liquid L10 is the same as the liquid L10 in the method of manufacturing a UFB-containing liquid according to the first embodiment, the reference numeral L10 will be used for the first liquid hereinafter.

Further, as shown in FIG. 5, the manufacturing apparatus 200 includes a supply unit 110 as a liquid supply means for supplying the second liquid L20, a liquid discharge head 120 as a discharge means, and the collision member 61. The manufacturing apparatus 200 may include the collision member support section 62.

The supply unit 110 supplies the second liquid L20, which is supplied into the supply unit 110 by a pump or the like, to the liquid discharge head 120 via a supply channel 112. The liquid discharge head 120 pressurizes the second liquid L20 supplied from the supply unit 110 and discharges it as liquid droplets 4b.

As shown in FIG. 6, the liquid discharge head 120 includes a channel forming member 121 for forming a channel 122 from a liquid inflow port 122a to a liquid outflow port 122b. The liquid inflow port 122a is connected to the supply channel 112 shown in FIG. 5, and the liquid outflow port 122b is connected to a recovery channel 113 shown in FIG. 5.

A portion of the channel forming member 121 is provided with a plate-shaped discharge port forming member (first discharge port forming member) 125 having a plurality of minute first discharge ports 126, an element holding member 127, and a plurality of piezoelectric elements (pressurizing means) 128.

FIG. 7 is a block diagram for describing a control unit of an apparatus for manufacturing a UFB-containing liquid according to the second embodiment. The control unit 102 of the manufacturing apparatus 200 is different from the control unit 102 of the manufacturing apparatus 100 in that, as shown in FIG. 7, it controls the pump 8 for sending a liquid to the nozzle 9 in addition to an object controlled by the control unit 102 of the manufacturing apparatus 100. Except for this point, the control unit 102 of the manufacturing apparatus 200 can have the same configuration as the control unit 102 of the manufacturing apparatus 100, and therefore, descriptions of identical configurations will be omitted.

### (Method of Manufacturing UFB-Containing Liquid)

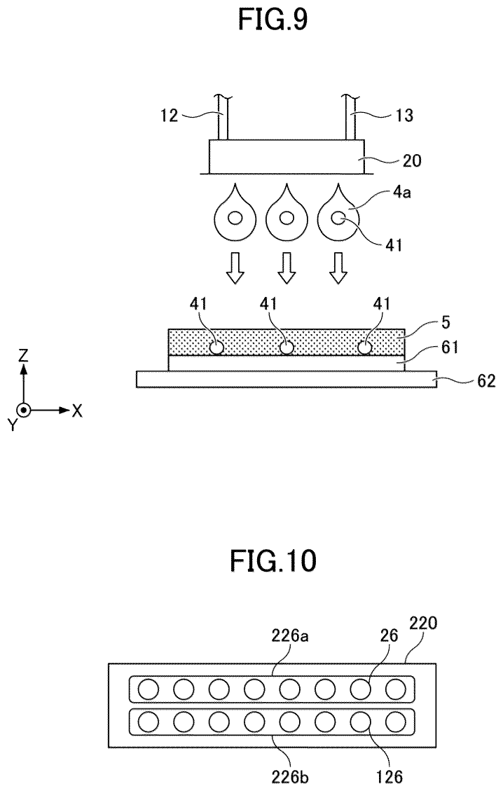

FIGS. 8A and 8B are schematic views for describing the method of manufacturing a UFB-containing liquid according to the second embodiment, and FIG. 9 is a schematic view for describing another example of the method of manufacturing a UFB-containing liquid according to the second embodiment. The method of manufacturing a UFB-containing liquid according to the second embodiment includes, as shown in FIG. 8A, a liquid film forming step of wetting the collision member 61 with a first liquid L10 to form a liquid film 5 on the collision member 61.

The method of manufacturing a UFB-containing liquid according to the second embodiment comprises a first supply step of supplying the second liquid L20 having a dissolved gas amount different from that of the first liquid L10 to a liquid supply region (first liquid supply region) in which a discharge port forming member (first discharge port forming member) 125 having a first discharge port 126 with a minute diameter is disposed, and a first discharge step of pressurizing the second liquid L20 supplied to the liquid supply region (first liquid supply region) and discharging the second liquid L20 as liquid droplets 4b from the first discharge port 126, as shown in FIG. 8(B). The liquid film forming step, the first supply step, and the first discharge step can be performed using the manufacturing apparatus 200.

### (Liquid Film Forming Step)

The first liquid L10 contains one or more nuclei (first nuclei) 41. The nuclei (first nuclei) 41 are substances containing carbon atoms and have a diameter less than or equal to 100 nm. As described above, the first liquid L10 is the same as the liquid L10 in the method of manufacturing a UFB-containing liquid according to the first embodiment, and therefore a description thereof is omitted.

In the liquid film forming step, for example, as shown in FIG. 8A, the first liquid L10 may be discharged from the nozzle 9 by the pressure of the pump 8 (FIG. 7) to form the liquid film 5 on the collision member 61. That is, in the liquid film forming step, the liquid film 5 including the nuclei (first nuclei) 41 is formed on the collision member 61. Further, in this step, the first liquid L10 may be discharged while the collision member 61 is rotating. In this case, the collision member 61 is rotated by the collision member rotating unit. Thus, the liquid film 5 can be formed relatively uniformly.

In the liquid film forming step, for example, the liquid film 5 having a thickness greater than 0 mm and less than or equal to 5 mm can be formed.

The liquid film forming step is not limited to the example shown in FIG. 8A, and the first liquid L10 may be sprayed by a spray nozzle or the like to form the liquid film 5 on the collision member 61 (spray coating), or the collision member 61 may be immersed in the first liquid L10 to form the liquid film 5 on the collision member 61 (dip coating).

In this step, the liquid film 5 may be formed on the collision member 61, as shown in FIG. 9, by using the manufacturing apparatus 100 shown in FIGS. 1 and 2. Specifically, the liquid film forming step may include a second supply step of supplying the first liquid L10 to a liquid supply region (second liquid supply region) in which a discharge port forming member (second discharge port forming member) 25 having a discharge port (second discharge port) 26 with a minute diameter is disposed, and a second discharge step of pressurizing the first liquid L10 supplied to the liquid supply region (second liquid supply region) and discharging the first liquid L10 as other liquid droplets 4a from the discharge port (second discharge port) 26.

Thus, in the liquid film forming step, the liquid film 5 can be accurately formed on the collision member 61 in accordance with, for example, a desired thickness of the liquid film 5, a formation region of the liquid film 5, and the like.

In the second discharge step, the flight velocity of the other liquid droplets 4a upon colliding with the collision member 61 may be less than 1 m/s.

### (First Supply Step)

The second liquid L20 need not contain the nucleus 41. The second liquid L20 may have a dissolved gas amount larger than that of the first liquid L10, or may have a dissolved gas amount smaller than that of the first liquid L10. The dissolved gas amount is, for example, a dissolved oxygen amount.

Examples of the second liquid L20 include ultrapure water, ozone water, hydrogen peroxide water, and the like.

In the example shown in FIGS. 8A and 8B, the second liquid L20 does not contain the nucleus 41, but the second liquid L20 may contain one or more nuclei (second nuclei) 41. The nuclei (second nuclei) 41 are substances containing carbon atoms and have a diameter less than or equal to 100 nm. The substances containing carbon atoms are substances containing one or more carbon atoms and may be, for example, organic compounds. That is, the second liquid L20 may be the same as the liquid (first liquid) L10.

When the second liquid L20 contains one or more nuclei (second nuclei) 41, in the first discharge step, the liquid droplet 4b containing the nuclei (second nuclei) 41 collides with the liquid film 5 containing the nuclei 41 formed in the liquid film forming step, so that a UFB-containing liquid having a higher concentration can be manufactured.

### (First Discharge Step)

As shown in FIG. 8B, the first discharge step is a step of discharging the liquid droplets 4b so as to collide with the liquid film 5 formed in the liquid film forming step. Further, the flight velocity of the liquid droplets 4b at the time of colliding with the liquid film 5 is greater than or equal to 1 m/s. With this configuration, according to the method of manufacturing a UFB-containing liquid of this embodiment, the UFB-containing liquid having a high concentration can be manufactured.

Specifically, when a liquid droplet 4b collides with the liquid film 5 containing the nuclei 41 at a flight velocity greater than or equal to 1 m/s, the following three phenomena are considered. (1) The liquid in the liquid droplet 4b is vaporized by the pressure fluctuation at the time of collision, thereby manufacturing the UFBs 42. (2) The liquid droplet 4b entrains ambient air at the time of collision, thereby manufacturing the UFBs 42. (3) The liquid droplet 4b entrains ambient air at the discharge step, thereby manufacturing microbubbles in the liquid droplet 4b, and the microbubbles are broken and divided at the time of collision, thereby manufacturing the UFBs 42.

As a result of the above, the concentration of the UFBs 42 in the liquid film 5 can be improved. Since the UFB-containing liquid obtained by the method of manufacturing a UFB-containing liquid according to the present embodiment has a higher concentration of UFBs than the conventional liquid, the UFB-containing liquid is superior with regard to the effects obtained by the UFBs, that is, with regard to the effects such as bactericidal power and cleaning power.

The volume of the second liquid L20 discharged from the first discharge port 126 is preferably greater than or equal to 1 μL and less than or equal to 10 μL.

The flight velocity of the liquid droplets 4b at the time of collision with the liquid film 5 is preferably greater than or equal to 1 m/s and less than or equal to 15 m/s, from the viewpoint of efficiently generating the UFBs 42.

The discharge direction of the liquid droplets 4b in the first discharge step is preferably perpendicular to the collision surface of the liquid droplets 4b with the liquid film 5, from the viewpoint of efficiently generating the UFBs 42.

In the first discharge step, the distance between the first discharge port 126 and the liquid film 5 is preferably greater than or equal to 0.1 mm and less than or equal to 30 mm, and more preferably greater than or equal to 0.5 mm and less than or equal to 10 mm, from the viewpoint of increasing the UFB concentration.

In the first discharge step, the collision member 61 may be cooled by a collision member cooling unit (not shown), from the viewpoint of efficiently generating the UFBs. The cooling temperature is preferably greater than or equal to the freezing point of each of the first liquid L10 and the second liquid L20 and less than or equal to room temperature (25° C.). As another option, the collision member cooling unit may be provided in the apparatus 200 for manufacturing the UFB-containing liquid, or the collision member cooling unit may be provided separately when manufacturing the UFB-containing liquid.

In the first discharge step, the liquid droplets 4b may be discharged while the collision member 61 is rotating. In this case, the collision member 61 is rotated by the collision member rotating unit. Thus, according to the method of manufacturing a UFB-containing liquid of the present embodiment, when the collision member 61 is an object to be cleaned, the UFB-containing liquid having a high concentration is generated on the collision member 61, and the UFB-containing liquid is diffused to the surface of the collision member 61 by the rotational centrifugal force, thereby cleaning the entire surface of the collision member 61. The collision member rotating unit includes, for example, a spin coater used in a spin coating method.

The method of manufacturing a UFB-containing liquid of the present embodiment may include, as another step, a recovery step for recovering the ultrafine bubble-containing liquid after the discharge step. The recovery step is suitably performed by a recovery means such as a spin coater with a waste liquid recovery mechanism.

### Third Embodiment

### (Apparatus for Manufacturing UFB-Containing Liquid)

The apparatus for manufacturing a UFB-containing liquid according to a third embodiment includes the manufacturing apparatus 100 according to the first embodiment and the manufacturing apparatus 200 according to the second embodiment. Incidentally, the manufacturing apparatus 100 and the manufacturing apparatus 200 need not include the collision member 61 and the collision member support section 62, but both may include the common collision member 61 and the collision member support section 62.

FIG. 10 is a schematic cross-sectional view showing another example of a liquid discharge head of the apparatus for manufacturing a UFB-containing liquid used in the manufacturing method of a UFB-containing liquid according to the third embodiment. FIG. 10 is a view as seen from a surface from which liquid is discharged. In the apparatus for manufacturing a UFB-containing liquid according to the third embodiment, as shown in FIG. 10, the liquid discharge head 120 of the manufacturing apparatus 200 and the liquid discharge head 20 of the manufacturing apparatus 100 may be integrated.

Specifically, as shown in FIG. 10, a liquid discharge head 220 may have a first discharge port line 226a and a second discharge port line 226b. The first discharge port line 226a is configured by arranging a plurality of discharge ports 26 for discharging the first liquid L10 as liquid droplets 4a in a row. The second discharge port line 226b is configured by arranging a plurality of first discharge ports 126 for discharging the second liquid L20 as other liquid droplets 4b in a row.

### (Method of Manufacturing UFB-Containing Liquid)

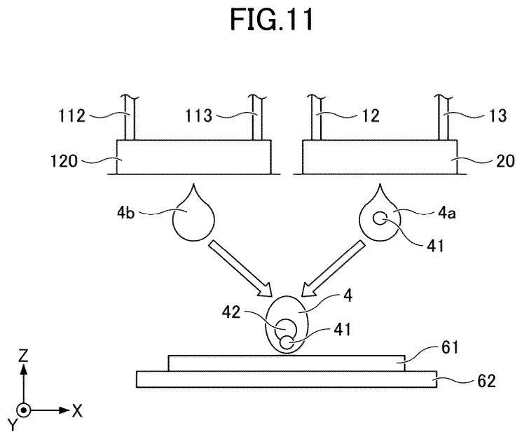

FIG. 11 is a schematic diagram for describing a method of manufacturing a UFB-containing liquid according to the third embodiment. The method of manufacturing a UFB-containing liquid according to the third embodiment comprises a third supply step of supplying the first liquid L10 to a liquid supply region (third liquid supply region) in which a discharge port forming member (third discharge port forming member) 25 having a discharge port (third discharge port) 26 with a minute diameter is disposed, and a third discharge step of pressurizing the first liquid L10 supplied to the liquid supply region (third liquid supply region) and discharging the first liquid L10 as liquid droplets 4a from the discharge port (third discharge port) 26.

The method of manufacturing a UFB-containing liquid according to the third embodiment comprises a fourth supply step of supplying the second liquid L20 having a dissolved gas amount different from that of the first liquid L10 to a first liquid supply region (fourth liquid supply region) in which a first discharge port forming member (fourth discharge port forming member) 125 having a first discharge port (fourth discharge port) 126 with a minute diameter is disposed, and a fourth discharge step of pressurizing the second liquid L20 supplied to the first liquid supply region (fourth liquid supply region) and discharging the liquid of the second liquid L20 from the first discharge port (fourth discharge port) 126 as the other liquid droplets 4b.

The third supply step and the third discharge step can be performed using the manufacturing apparatus 100, and the fourth supply step and the fourth discharge step can be performed using the manufacturing apparatus 200.

### (Third Supply Step and Third Discharge Step)

The first liquid L10 contains one or more nuclei (first nuclei) 41. The nuclei (first nuclei) 41 are substances containing carbon atoms and have a diameter less than or equal to 100 nm. As described above, the first liquid L10 is the same as the liquid L10 in the method of manufacturing a UFB-containing liquid according to the first embodiment, and the third supply step and the third discharge step are the same as the supply step and the discharge step in the first embodiment, and so descriptions thereof are omitted.

### (Fourth Supply Step)

The fourth supply step and the fourth discharge step can be performed by using the manufacturing apparatus 200.

The second liquid L20 does not need to contain the nucleus 41. As described above, the second liquid L20 is the same as the second liquid L20 in the second embodiment, and the fourth supply step is the same as the supply step in the second embodiment, and so descriptions thereof are omitted.

In the example shown in FIG. 11, the second liquid L20 does not contain the nucleus 41, but the second liquid L20 may contain one or more nuclei (second nuclei) 41. The nuclei (second nuclei) are substances containing carbon atoms and may have a diameter less than or equal to 100 nm. The substances containing carbon atoms are substances containing one or more carbon atoms and may be, for example, organic compounds. That is, the second liquid L20 may be the same as the first liquid L10.

In a case where the second liquid L20 contains one or more nuclei (second nuclei) 41, the liquid droplets 4b containing the nuclei (second nuclei) collide with the liquid droplets 4a containing the nuclei (first nuclei) 41 in the fourth discharge step, whereby the UFB-containing liquid having a high concentration can be manufactured.

### (Fourth Discharge Step)

In the fourth discharge step, as shown in FIG. 11, the other liquid droplets 4b are discharged so as to collide with the liquid droplets 4a formed in the third discharge step, and the flight velocity of the other liquid droplets 4b at the time of colliding with the liquid droplets 4a is greater than or equal to 1 m/s. With this configuration, according to the method of manufacturing a UFB-containing liquid of the present embodiment, it is possible to manufacture a UFB-containing liquid having a high concentration.

Specifically, when the other liquid droplets 4b collide with the liquid droplets 4a containing the nuclei 41 at a flight velocity greater than or equal to 1 m/s, the following three phenomena are considered. (1) The liquid in the liquid droplets 4a and the liquid in the liquid droplets 4b are vaporized by the pressure fluctuation at the time of collision, and the UFBs 42 are generated in the liquid droplets 4 formed by merging both liquid droplets. (2) When the liquid droplets 4a and the liquid droplets 4b each entrain the surrounding outside air at the time of collision, the UFBs 42 are generated in the liquid droplets 4 formed by merging both liquid droplets. (3) When the liquid droplets 4a entrain the outside air at the second discharge step, microbubbles are generated in the liquid droplets 4a, and the microbubbles are broken and divided at the time of collision, thereby generating the UFBs 42 in the liquid droplets 4 formed by merging both liquid droplets.

In the fourth discharge step, the other liquid droplets 4b may be caused to collide with the liquid droplets 4a in the air, or may be caused to collide with the liquid droplets 4a on the collision member 61.

As a result, the concentration of the UFBs 42 in the liquid droplets 4 can be improved. Since the UFB-containing liquid obtained by the method of manufacturing a UFB-containing liquid according to the present embodiment has a higher concentration of UFBs than that of the conventional liquid, the UFB-containing liquid is superior with regard to the effects obtained by the UFBs, that is, with regard to the effects such as sterilization and cleaning power.

The volume of the second liquid L20 discharged from the first discharge port (fourth discharge port) 126 is preferably greater than or equal to 1 μL and less than or equal to 10 μL.

The flight velocity of the other liquid droplets 4b upon colliding with the liquid droplets 4a is preferably greater than or equal to 1 m/s and less than or equal to 15 m/s, from the viewpoint of efficiently generating the UFBs 42.

The discharge direction of the other liquid droplets 4b in the fourth discharge step is preferably toward the liquid droplets 4a, from the viewpoint of efficiently generating the UFBs 42.

In the fourth discharge step, the distance between the first discharge port (fourth discharge port) 126 and the collision member 61 is preferably greater than or equal to 0.1 mm and less than or equal to 30 mm, and more preferably greater than or equal to 0.5 mm and less than or equal to 10 mm, from the viewpoint of increasing the UFB concentration.

In the fourth discharge step, the collision member 61 may be cooled by a collision member cooling unit (not shown), from the viewpoint of efficiently generating the UFBs. The cooling temperature is preferably greater than or equal to the freezing point of the first liquid L10 and the second liquid L20 and less than or equal to room temperature (25° C.). As another option, the collision member cooling unit may be provided in the UFB-containing liquid manufacturing apparatus 100 or the manufacturing apparatus 200, or the collision member cooling unit may be separately provided when the UFB-containing liquid is manufactured.

In the fourth discharge step, the other liquid droplets 4b may be discharged while the collision member 61 is rotating. In this case, the collision member 61 is rotated by the collision member rotating unit. Thus, according to the method of manufacturing the UFB-containing liquid of the present embodiment, when the collision member 61 is an object to be cleaned, a UFB-containing liquid having a high concentration is generated on the collision member 61, and the UFB-containing liquid is diffused to the surface of the collision member 61 by the rotational centrifugal force, thereby cleaning the entire surface of the collision member 61. The collision member rotating unit includes, for example, a spin coater used in a spin coating method.

The method of manufacturing a UFB-containing liquid of the present embodiment may include, as another step, a recovery step for recovering the ultrafine bubble-containing liquid after the discharge step. The recovery step is suitably performed by a recovery means such as a spin coater with a waste liquid recovery mechanism.

What is claimed is:

1. A method of manufacturing an ultrafine bubble-containing liquid, comprising:
a supply step of supplying a liquid to a liquid supply region provided in which a discharge port forming member having a discharge port with a minute diameter is arranged; and
a discharge step of pressurizing the liquid supplied to the liquid supply region and discharging the liquid as a liquid droplet from the discharge port, wherein
the liquid contains one or more nuclei,
the nuclei are substances containing carbon atoms and have a diameter less than or equal to 100 nm, and
the discharge step is a step of discharging the liquid droplet so as to collide with a collision member, wherein a flight velocity of the liquid droplet upon colliding with the collision member is greater than or equal to 1 m/s.

2. The method of manufacturing an ultrafine bubble-containing liquid according to claim 1, wherein
a distance between the discharge port and the collision member is less than or equal to 10 mm.

3. The method of manufacturing an ultrafine bubble-containing liquid according to claim 1, wherein
in the discharge step, the liquid droplet is discharged while the collision member is rotating.

4. A method of manufacturing an ultrafine bubble-containing liquid, comprising:
a liquid film forming step of forming a liquid film on a collision member by wetting the collision member with a first liquid;
a first supply step of supplying a second liquid having a dissolved gas amount different from that of the first liquid to a first liquid supply region in which a first discharge port forming member having a first discharge port with a minute diameter is arranged; and
a first discharge step of pressurizing the second liquid supplied to the first liquid supply region and discharging the second liquid as one liquid droplet from the first discharge port, wherein
the first liquid contains one or more first nuclei,
the first nuclei are substances containing carbon atoms and have a diameter less than or equal to 100 nm, and
the first discharge step is a step of discharging the one liquid droplet so as to collide with the liquid film formed in the liquid film forming step, with a flight velocity of the one liquid droplet upon colliding with the liquid film being greater than or equal to 1 m/s.

5. The method of manufacturing an ultrafine bubble-containing liquid according to claim 4, wherein
the liquid film forming step includes:
a second supply step of supplying the first liquid to a second liquid supply region in which a second discharge port forming member having a second discharge port with a minute diameter is arranged; and
a second discharge step of pressurizing the first liquid supplied to the second liquid supply region and discharging the first liquid as another liquid droplet from the second discharge port.

6. The method of manufacturing an ultrafine bubble-containing liquid according to claim 4, wherein
the second liquid contains one or more second nuclei, and
the second nuclei are substances containing carbon atoms and have a diameter less than or equal to 100 nm.

7. The method of manufacturing an ultrafine bubble-containing liquid according to claim 4, further comprising:
a third supply step of supplying the first liquid to a third liquid supply region in which a third discharge port forming member having a third discharge port with a minute diameter is arranged;
a third discharge step of pressurizing the first liquid supplied to the third liquid supply region and discharging the first liquid as one liquid droplet from the third discharge port;
a fourth supply step of supplying the second liquid having a dissolved gas amount different from that of the first liquid to a fourth liquid supply region in which a fourth discharge port forming member having a fourth discharge port with a minute diameter is arranged; and
a fourth discharge step of pressurizing the second liquid supplied to the fourth liquid supply region and discharging the second liquid as another liquid droplet from the fourth discharge port, wherein
the first liquid contains one or more of the first nuclei,
the first nuclei are substances containing carbon atoms and have a diameter less than or equal to 100 nm, and
the fourth discharge step is a step of discharging the other liquid droplet so as to collide with the one liquid droplet formed in the third discharge step, with the flight velocity of the other liquid droplet upon colliding with the one liquid droplet being greater than or equal to 1 m/s.

8. The method of manufacturing an ultrafine bubble-containing liquid according to claim 7, wherein
the second liquid contains one or more second nuclei, and
the second nuclei are substances containing carbon atoms and have a diameter less than or equal to 100 nm.
